(19) United States
(12) Patent Application Publication
(10) Pub. No.: US 2009/0237409 A1
(43) Pub. Date: Sep. 24, 2009

(54) SYSTEM AND METHOD FOR A FULLY EDITABLE OPERATION IN THE CONTEXT OF A SOLVER CONTROLLED ENVIRONMENT

(76) Inventors: Dick Baardse, Herogenbosh (NL); Manoj Radhakrishnan, Cypress, CA (US)

Correspondence Address: Siemens Corporation;Intellectual Property Department, 170 Wood Avenue South, Iselin, NJ, 08830, US

(21) Appl. No.: 12/052,610

(22) Filed: Mar. 20, 2008

(51) Int. Cl. G06T 11/20

(52) U.S. Cl. 345/442

(57) ABSTRACT

A system, method, and computer program for editing offsets, comprising connecting one or more input curves to a constraint system by constraints; offsetting output curves from said input curves by an operation; and creating a plurality of constraints among said input curves and said output curves; whereby editing said operation transforms said input curves and said output curves in a bidirectional manner, and appropriate means and computer-readable instructions.

### TECHNICAL FIELD

The presently preferred embodiment of the innovations described herein relate generally to software applications. More specifically, the presently preferred embodiment relates to fully editable operation in the context of a constraint system.

### BACKGROUND

In the art of computer aided design (CAD) software systems, offset functionality in a constraint controlled environment is often limited to the creation of curves. After those curves have been created, the only way to modify the result is by interacting with the curves of the constraints. Further, offsetting multiple disconnected closed or open looks is often not possible or directional side controls are not available for separated chains.

Creating offset curves in a constraint controlled environment like a sketch in a CAD system often leads to results where the offset curves are not handled well during modification. The way in which such curves behave after trimming and extending is often unpredictable. Some solutions exist where copies of curves are created and the original curves are then hidden from the user—these situations lead to complicated sketches.

What is needed is a system and method that allows the original curves and the created offset curves to be trimmed and extended without copying while preserving predictable behavior.

### SUMMARY

To achieve the foregoing, and in accordance with the purpose of the presently preferred embodiment as described herein, the present application provides a computer-implemented method for editing offsets, comprising connecting one or more input curves to a constraint system by constraints; offsetting output curves from said input curves by an operation; and creating a plurality of constraints among said input curves and said output curves; whereby editing said operation transforms said input curves and said output curves in a bidirectional manner. The method, wherein said plurality of constraints can have a primary constraint and a plurality of secondary constraints. The method, wherein said operation offsets said output curves by a value. The method, wherein said constraints can be applied manually. The method, wherein a user can modify parameters of said operation. The method, wherein said offsetting creates an offset constraint. The method, wherein an external operation on said curves interacts through said offset constraint.

An advantage of the presently preferred embodiment is to provide a computer-program product tangibly embodied in a machine readable medium to perform a method for editing offsets, comprising instructions operable to cause a computer to connect one or more input curves to a constraint system by constraints; offset output curves from said input curves by an operation; and create a plurality of constraints among said input curves and said output curves; whereby editing said operation transforms said input curves and said output curves in a bidirectional manner. The computer-program product, wherein said plurality of constraints can have a primary constraint and a plurality of secondary constraints. The computer-program product, wherein said operation offsets said output curves by a value. The computer-program product, wherein said constraints can be applied manually. The computer-program product, wherein a user can modify parameters of said operation. The computer-program product, wherein said offsetting creates an offset constraint. The computer-program product, wherein an external operation on said curves interacts through said offset constraint.

Another advantage of the presently preferred embodiment is to provide a data processing system having at least a processor and accessible memory to implement a method for editing offsets, comprising means for connecting one or more input curves to a constraint system by constraints; means for offsetting output curves from said input curves by an operation; and means for creating a plurality of constraints among said input curves and said output curves.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIGS. 2a and 2b are logic flow diagrams of a constraint system with curves;

FIG. 3 illustrates a logic flow diagrams of a constraint system with curves; and

FIG. 4 is a block diagram of a computer environment in which the presently preferred embodiment may be practiced.

### DETAILED DESCRIPTION OF THE PREFERRED EMBODIMENTS

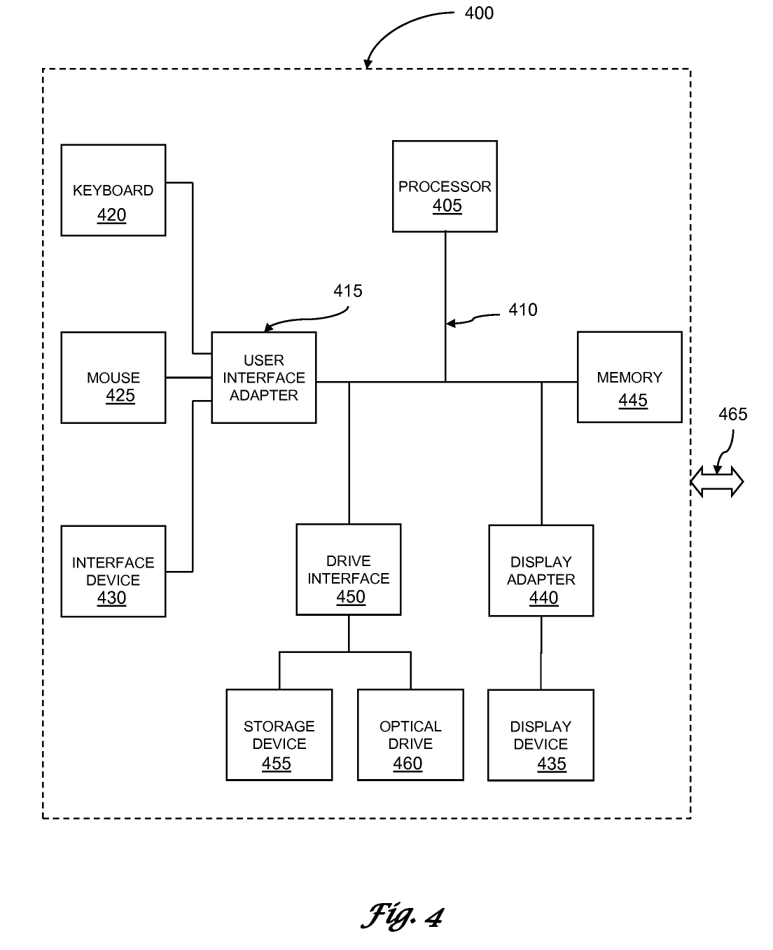

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for a fully editable operation in the context of a solver controlled environment. Now therefore, in accordance with the presently preferred embodiment, an operating system executes on a computer, such as a general-purpose personal computer. FIG. 4 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implement particular abstract data types. The presently preferred embodiment may be performed in any of a variety of known computing environments.

Referring to FIG. 4, an exemplary system for implementing the presently preferred embodiment includes a general-purpose computing device in the form of a computer 400, such as a desktop or laptop computer, including a plurality of related peripheral devices (not depicted). The computer 400 includes a microprocessor 405 and a bus 410 employed to connect and enable communication between the microprocessor 405 and a plurality of components of the computer 400 in accordance with known techniques. The bus 410 may be any of several types of bus structures including a memory bus or memory controller, a peripheral bus, and a local bus using any of a variety of bus architectures. The computer 400 typically includes a user interface adapter 415, which connects the microprocessor 405 via the bus 410 to one or more interface devices, such as a keyboard 420, mouse 425, and/or other interface devices 430, which can be any user interface device, such as a touch sensitive screen, digitized pen entry pad, etc. The bus 410 also connects a display device 435, such as an LCD screen or monitor, to the microprocessor 405 via a display adapter 440. The bus 410 also connects the microprocessor 405 to a memory 445, which can include ROM, RAM, etc.

The computer 400 further includes a drive interface 450 that couples at least one storage device 455 and/or at least one optical drive 460 to the bus. The storage device 455 can include a hard disk drive, not shown, for reading and writing to a disk, a magnetic disk drive, not shown, for reading from or writing to a removable magnetic disk drive. Likewise the optical drive 460 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 400.

The computer 400 can communicate via a communications channel 465 with other computers or networks of computers. The computer 400 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 445 of the computer 400. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### System

The implementation of the presently preferred embodiment requires the use of a constraint system that can come in form of an application, such as PGM and DCM offered by Siemens Product Lifecycle Management Software, Inc. (Plano, Tex.), or other geometric modelers and constraint solver systems, which is designed to provide functions to support the development of CAD systems for geometric construction of parts using constraints. The geometric entities managed by DCM may have dimensional constraints (distance, angle, radius, etc.) or logical constraints (perpendicularity, parallelism, coincidence, etc.) among them. A feature common to CAD applications is the ability to offset an object by first defining a reference point, and then calculating an offset distance from the reference point. When using the constraint solver, it is preferable to maintain the desired spatial relations asserted when the constraints were formed. Example functions provided by constraint solvers, including those provided by DCM, allow offset constraints to have disjoint chains and support end constraints when solving.

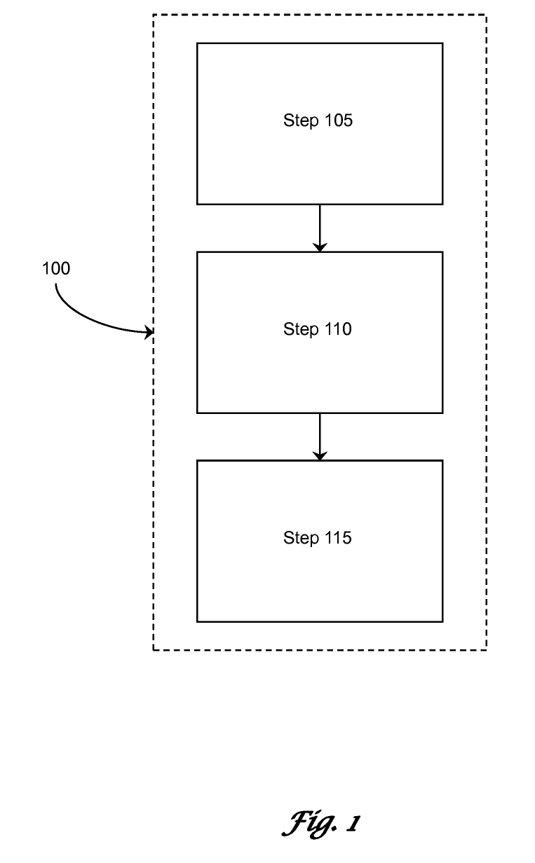

FIG. 1 is a logic flow diagram of the method employed by the presently preferred embodiment. Referring to FIG. 1, a computer implemented method 100 is employed to provide a fully editable operation in the context of a solver controlled environment, having steps described in more detail below. To begin, the system connects input curves to a constraint system by constraints, where it is understood that “curve” can also be a straight line (Step 105). Then, the system offsets output curves from the input curves by an operation (Step 110). Next, the system creates a primary constraint and a plurality of secondary constraints between the input curves and the output curves (Step 115) so that editing the operation transforms the input curves and the output curves in a bidirectional manner, meaning the input curves affect the output curves, and the output curves affect the input curves.

### Bidirectional Constraint System

The presently preferred embodiment discloses a bidirectional constraint system that that creates an editable set of constraints between solver-controlled inputs to generate solver-controlled outputs. The relationship between inputs and outputs is based on multiple constraints that are solved simultaneously with the inputs and outputs. The inputs and outputs affect each other in a bi-directional way. Downstream modifications are allowed and work in context of the operation, internal constraints can be removed. In other words: later modifications edit existing operations. The operation is fully editable; the user can fully redefine the operation. The editing of the set of constraints produced by the operation is done in the exact same way as creation.

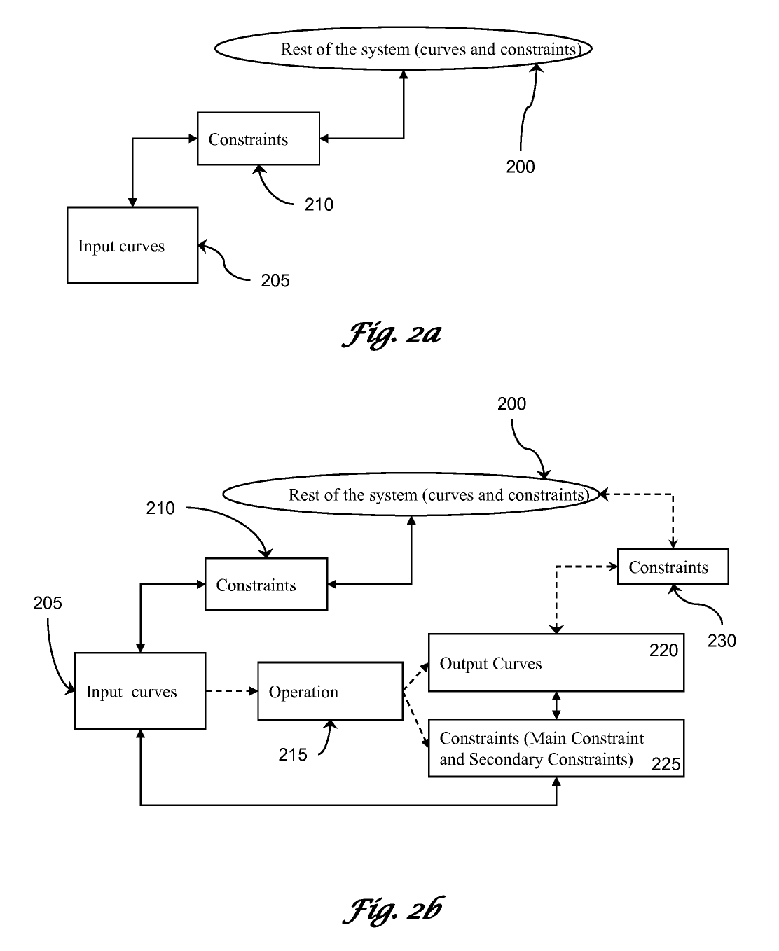

FIGS. 2a and 2b are logic flow diagrams of a constraint system with curves. Referring further to FIG. 2a, a constraint system 200, for example, one that utilizes the constraint solver discussed above, connects a number of input curves 205 by a corresponding number of constraints 210. Referring to FIG. 2b, the computer user determines to modify, or edit, the input curves 205 by an offset operation 215, that creates one or more output curves 220 corresponding to the input curve 205 and various constraints 225. The various constraints 225 correspond to one main constraint and multiple secondary constraints between the input curve 205 and the output curve 220. Should a main constraint be removed, the secondary constraints will also be removed, because by definition the secondary constraints depend upon the main (or primary) constraints. Now, the input curves 205 and the output curves 220 affect each other in a bidirectional way via the constraints 210. Editing the operation 215 allows the user to restore or move output curves 220 or reset other parameters and properties of the operation 215 (by following the process of the dashed arrows again). Additionally, other constraints can be manually applied between the output curves 220 and the rest of the constraint system 200, generally shown at 230.

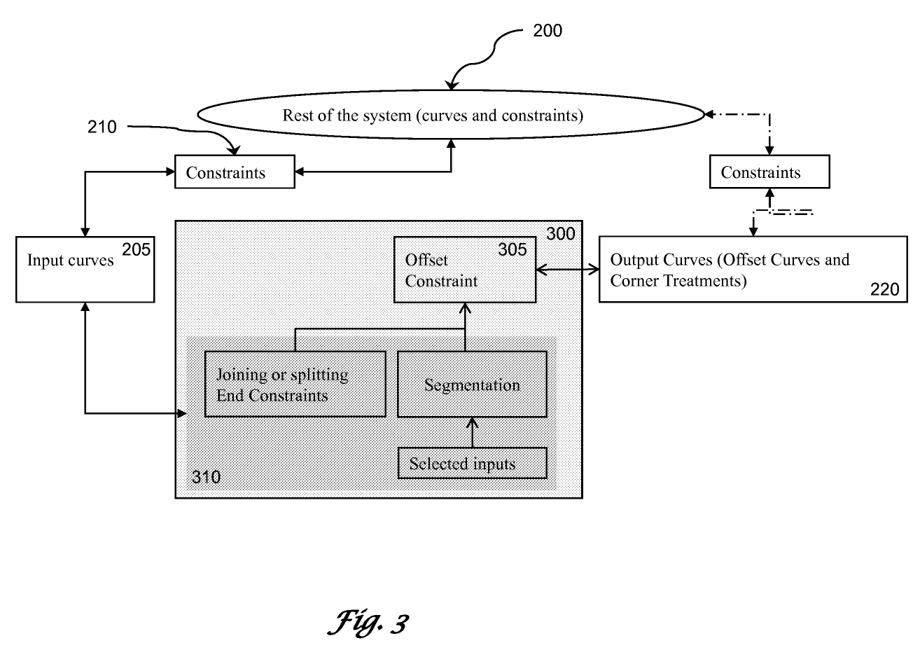

FIG. 3 illustrates a logic flow diagram of a constraint system with curves. Referring now to FIG. 3, for example, a fully editable operation 300 for offset curves is shown, where the offset is bidirectional. External operations on the input curves 210 or output curves 220 interact through an offset constraint 305 with the objects generally shown in 310. The interaction means that the fully editable operation 300 can be edited by not only the user but also other operations, described in more detail below.

### CONCLUSION

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be an assembled, compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment, such as trimming or extending curves, etc. Therefore, other implementations are within the scope of the following claims.

What is claimed is:

1. A computer-implemented method for editing offsets, comprising:
connecting one or more input curves to a constraint system by constraints;
offsetting output curves from said input curves by an operation; and
creating a plurality of constraints among said input curves and said output curves;
whereby editing said operation transforms said input curves and said output curves in a bidirectional manner.

2. The method of claim 1, wherein said plurality of constraints can have a primary constraint and a plurality of secondary constraints.

3. The method of claim 1, wherein said operation offsets said output curves by a value.

4. The method of claim 1, wherein said constraints can be applied manually.

5. The method of claim 1, wherein a user can modify parameters of said operation.

6. The method of claim 1, wherein said offsetting creates an offset constraint.

7. The method of claim 6, wherein an external operation on said curves interacts through said offset constraint.

8. A computer-program product tangibly embodied in a machine readable medium to perform a method for editing offsets, comprising instructions operable to cause a computer to:
connect one or more input curves to a constraint system by constraints;
offset output curves from said input curves by an operation; and
create a plurality of constraints among said input curves and said output curves;
whereby editing said operation transforms said input curves and said output curves in a bidirectional manner.

9. The computer-program product of claim 8, wherein said plurality of constraints can have a primary constraint and a plurality of secondary constraints.

10. The computer-program product of claim 8, wherein said operation offsets said output curves by a value.

11. The computer-program product of claim 8, wherein said constraints can be applied manually.

12. The computer-program product of claim 8, wherein a user can modify parameters of said operation.

13. The computer-program product of claim 8, wherein said offsetting creates an offset constraint.

14. The computer-program product of claim 13, wherein an external operation on said curves interacts through said offset constraint.

15. A data processing system having at least a processor and accessible memory to implement a method for editing offsets, comprising:
means for connecting one or more input curves to a constraint system by constraints;
means for offsetting output curves from said input curves by an operation; and
means for creating a plurality of constraints among said input curves and said output curves.
